(19) United States
(12) Patent Application Publication
(10) Pub. No.: US 2011/0168504 A1
(43) Pub. Date: Jul. 14, 2011

(54) EMERGENCY BRAKING SYSTEM

(75) Inventor: Joong K. Lee, Chatham (CA)

(73) Assignee: KSR Technologies Co., Ridgetown (CA)

(21) Appl. No.: 12/985,422

(22) Filed: Jan. 6, 2011

Related U.S. Application Data
(60) Provisional application No. 61/294,881, filed on Jan. 14, 2010.

(51) Int. Cl. B60T 7/12; F16D 65/34; B60T 7/00; B60T 7/06

(52) U.S. Cl. 188/106 P

(57) ABSTRACT

An emergency automotive braking system in which a vehicle brake is movable between a braking position and a non braking position. An electrically powered actuator is mechanically coupled to the vehicle brake and, when energized, moves the vehicle brake from the non braking and to the braking position. A charging circuit electrically charges a capacitor bank. A collision avoidance system generates a trigger output signal upon detection of a potential vehicle collision to a control system which, in response to the trigger signal, electrically connects the capacitor bank to the actuator to energize the actuator.

### CROSS REFERENCE TO RELATED APPLICATIONS

This application claims priority of U.S. Provisional Patent Application Ser. No. 61/294,881 filed Jan. 14, 2010, which is incorporated herein by reference.

### BACKGROUND OF THE INVENTION

I. Field of the Invention

The present invention relates to an emergency braking system for an automotive vehicle.

II. Description of Related Art

Many modern automotive vehicles are equipped with a collision avoidance system. Some systems merely notify the driver of a potential hazard in the vehicle's path. Other collision avoidance systems, however, override the vehicle control by the driver and control the speed of the vehicle and/or apply the vehicle brakes in response to a potential hazard detected by the collision avoidance system.

In some situations it is necessary to activate the brakes rapidly in order to avoid a collision or other hazard. In such systems, an electromagnetic actuator or electric motor is utilized to apply the brakes to slow the vehicle.

One disadvantage with these previously known systems is that the electromagnetic actuator or motor utilized to apply the brakes requires high current for rapid actuation. However, these systems are powered by the vehicle battery which is not only relatively low voltage, typically 12 volts, but also is unable to provide the high current necessary for rapid actuation of the electromagnetic actuator or electric motor which, in turn, results in slower actuation of the brakes. In some situations, the delay in the brake actuation results in a vehicle collision which could have been avoided if a more rapid brake actuation was employed.

### SUMMARY OF THE PRESENT INVENTION

The present invention provides an emergency braking system which overcomes the above-mentioned disadvantages of the previously known emergency braking systems.

In brief, the emergency braking system of the present invention is provided for use with an automotive vehicle having a passenger operated vehicle brake movable between a braking position and a non braking position. An electrically powered actuator is mechanically coupled to the vehicle brake such that, when energized, the actuator moves the vehicle brake from the non braking and to the braking position.

At least one capacitor, and preferably a capacitor bank, is provided to store electrical charge for use by the emergency braking system. A charging circuit electrically charges the capacitors, preferably through use of a voltage multiplier. The voltage multiplier thus enables an increase in the amount of electrical charge stored by the capacitor bank.

A collision avoidance system generates a trigger signal upon detection of a potential vehicle collision or other hazard. The collision avoidance system provides this trigger signal to a control circuit which, in response to the trigger circuit, electrically connects the capacitor bank to the actuator in order to energize the actuator and thus move the vehicle brake to the braking position.

Since the current discharge from the capacitor may change instantaneously, the capacitor bank provides a current spike to the actuator. This, in turn, results in a more rapid actuation of the vehicle brake than previously obtainable by the previously known systems.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a preferred embodiment of the present invention;

FIG. 2 is a view illustrating a vehicle brake in an automotive vehicle;

FIG. 3 is a view similar to FIG. 2, but illustrating a modification thereof;

FIG. 4 is a schematic view illustrating a preferred embodiment of the present invention;

FIG. 5 is a schematic view illustrating the vehicle switch control system; and

FIG. 6 is a view similar to FIG. 4, but illustrating a modification thereof.

### DETAILED DESCRIPTION OF PREFERRED EMBODIMENTS OF THE PRESENT INVENTION

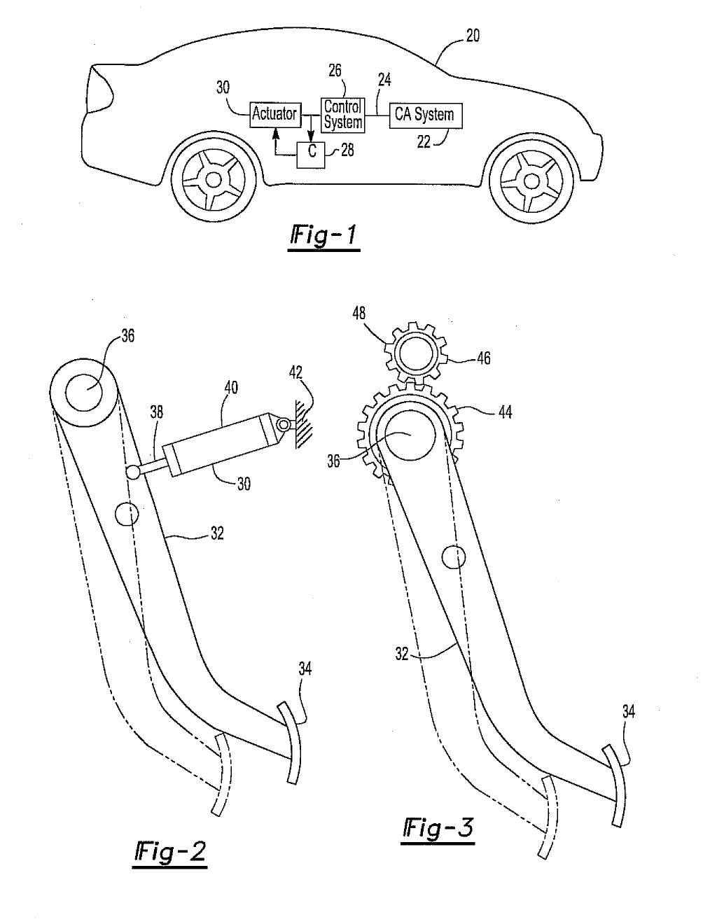

With reference first to FIG. 1, an automotive vehicle 20 is shown having a collision avoidance system 22. The collision avoidance system 22 may be of any conventional construction and generates a trigger signal on its output 24 to a control system 26 upon detection of a potential vehicle collision or other hazard. In a fashion that will be subsequently described in greater detail, the control system 26 then discharges a capacitor bank 28 to energize an electromechanical actuator 30 which is mechanically coupled to the vehicle brake.

With reference now to FIG. 2, a typical vehicle brake 32 is shown having a pedal 34 which is operated by the vehicle driver. Depression of the pedal 34 from the non braking position, illustrated in solid line, to a braking position, illustrated in phantom line, causes the vehicle brake 32 to pivot about a pivot pin 36 and apply the vehicle brakes to slow the vehicle.

The electromechanical actuator 30 is illustrated in FIG. 2 as a solenoid having an armature 38 pivotally connected to the brake 32 and a solenoid body 40 attached to a fixed point 42 in the vehicle, such as the frame. Upon energization of the solenoid, the solenoid armature 38 extends from the body 40 thus pivoting the brake 32 from a non braking and to a braking position.

With reference now to FIG. 3, a modification of the invention is shown in which a gear 44, or at least a segment of a gear 44, is attached to the brake 32 so that the gear 44 is coaxial with the pivot pin 36 for the brake 32. The gear 42, furthermore, is fixedly secured to the brake 32 so that the gear 44 and brake 32 pivot in unison with each other.

Unlike the actuator 30 illustrated in FIG. 2, the actuator 30 in FIG. 3 comprises an electrically powered motor 46. The motor 46 includes an output shaft fixedly coupled to a pinion 48 which is in mesh with the gear 44 attached to the brake 32. Consequently, upon energization of the electric motor 46, the motor 46 rotatably drives the pinion 48 which, in turn, pivots the brake 32 from its non braking position, illustrated in solid line, and to a braking position, illustrated in phantom line.

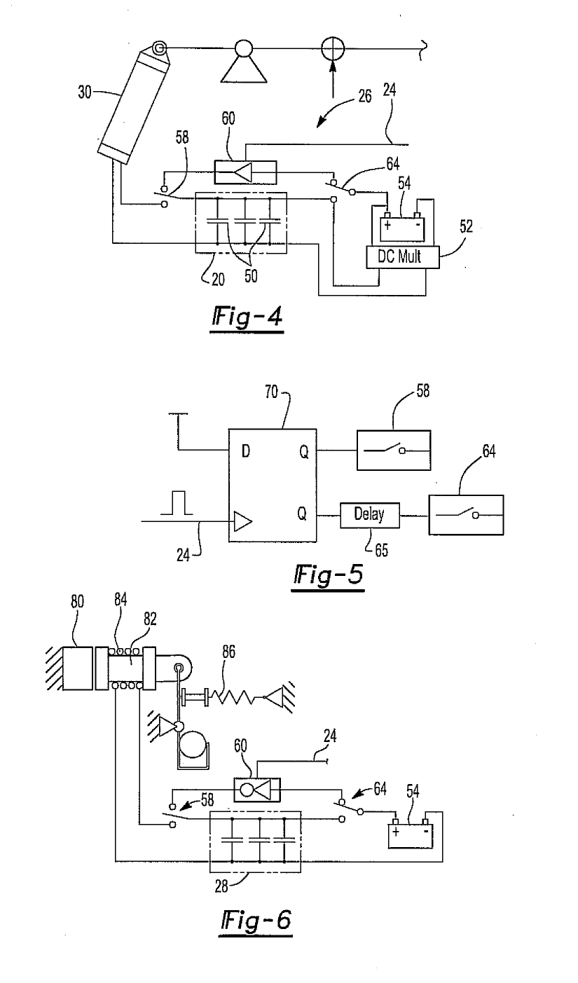

With reference now to FIG. 4, the capacitor 28 preferably comprises a bank of capacitors 50 which are electrically connected in parallel with each other. The capacitors 50 are selected such that they are able to maintain a high charge, such as electrolytic capacitors.

In order to electrically charge the capacitors 50, a battery 52 for the automotive vehicle 20 is electrically connected, preferably through a voltage multiplying circuit 54, to the capacitors 50. The voltage multiplying circuit 54 thus enables the capacitors 50 to be charged to a higher voltage than the battery, e.g. 48 volts, thus increasing the electrical charge stored in the capacitors 50.

Still referring to FIG. 4, the control circuit 26 includes a first switch 58 which is normally maintained in an open position as shown in FIG. 4. When in the open position, the switch 58 electrically isolates the capacitor bank 28 from the brake actuator 30. However, upon receipt of a trigger signal from the collision avoidance system 22 on line 24, a switch control 60 immediately closes the switch 58 thus discharging the charge stored by the capacitors 50 to the actuator 30. In view of the high current which is discharged from the capacitor bank 28 to the actuator 30, the switch 58 must be a high current switch, such as a solenoid relay.

Still referring to FIG. 4, the switch control 60 also controls the closure of a second switch 64 electrically connected between the battery 52 and the solenoid bank 28. The switch 64 is normally open as shown in FIG. 4 thus protecting the battery from the high current discharge from the capacitor bank 28. However, after a short delay following discharge of the capacitor bank 28 after closure of the first switch 58, the switch control 60 actuates the second switch 64 to a closed position thus electrically connecting the battery 52 with the actuator 30 to maintain the actuator 30 in its energized condition. Unlike the switch 58, however, the switch 64 may be a much smaller current switch, such as a FET.

With reference now to FIG. 5, one circuit to control the sequential actuation of the switches 58 and 64 is shown and comprises a D flip-flop 70 having its Q output controlling the actuation of the first switch 58 and its Q̅ output controlling the actuation of the switch 64 through a time delay circuit 65. The D input to the flip-flop 70 is held at a 1 level while the trigger signal 24 from the collision avoidance system 22 is coupled to the trigger input for the flip-flop 70. Consequently, the flip-flop 70 sequentially actuates the switches 58 and 64 with a delay determined by the delay circuit 65.

While in the preferred embodiment of the invention the high current provided from the capacitor bank 28 to the electrically operated actuator is used to energize the actuator, it will also be understood that the current pulse from the capacitor bank 28 may also be used as a decoupling force. For example, as shown in FIG. 6, a permanent magnet 80 is used to maintain an electromagnetic core 82 in a first position in which the brake pedal is in a non braking position. Upon receipt of the current pulse from the capacitor bank 28 to a coil 84 surrounding the core 82, the current pulse effectively decouples the core 82 from the permanent magnet 80. This, in turn, allows a spring mechanism 86 mechanically coupled to the vehicle brake 32 to move the vehicle brake 32 from its non braking position and to its braking position.

From the foregoing, it can be seen that the present invention provides a simple and yet highly effective emergency braking system for an automotive vehicle. Unlike the previously known systems, the system of the present invention provides a high current pulse in response to a trigger signal from a collision avoidance system to provide rapid movement of the vehicle brake from the non braking and to the braking position.

Having described my invention, however, many modifications thereto will become apparent to those skilled in the art to which it pertains without deviation from the spirit of the invention as defined by the scope of the appended claims.

I claim:

1. An emergency automotive vehicle braking system comprising:
a vehicle brake movable between a braking position and a non braking position,
an electrically powered actuator mechanically coupled to said vehicle brake, said actuator operable when energized to move said vehicle brake from said non braking position to said braking position,
at least one capacitor,
a charging circuit which electrically charges said at least one capacitor,
a collision avoidance system which generates a trigger signal upon detection of a potential vehicle collision,
a control system which, in response to said trigger signal, electrically connects said at least one capacitor to said actuator to energize said actuator.

2. The system as defined in claim 1 wherein said at least one capacitor comprises a bank of capacitors.

3. The system as defined in claim 1 and further comprising a battery, and wherein said control system sequentially electrically connects said at least one capacitor to said actuator and subsequently electrically connects said battery to said actuator after a time delay in response to said trigger signal.

4. The system as defined in claim 1 and further comprising a battery, and wherein said charging circuit comprises a voltage multiplier electrically connected between said battery and said at least one capacitor.

5. The system as defined in claim 1 wherein said actuator comprises a solenoid.

6. The system as defined in claim 5 wherein said brake includes a pedal and wherein said solenoid is mechanically connected to said pedal.

7. The system as defined in claim 1 wherein said actuator comprises an electric motor.

8. The system as defined in claim 7 wherein said brake includes a pedal and wherein said electric motor is mechanically connected to said pedal.

9. The system as defined in claim 8 wherein said electric motor is mechanically coupled to said pedal through a pinion.

10. The system as defined in claim 1 wherein said actuator comprises an electromagnetic core coupled to said brake and maintained in said non braking position by a permanent magnet and a spring coupled to said core which urges said brake toward said braking position.
